(19) United States
(12) Patent Application Publication
(10) Pub. No.: US 2020/0230640 A1
(43) Pub. Date: Jul. 23, 2020

(54) METAL ARTICLE EMBEDDED WITH TAGGANT AND METHODS OF MAKING

(71) Applicant: Honeywell International Inc., Morris Plains, NJ (US)

(72) Inventor: Marc D. Ruggiero, Spokane Valley, WA (US)

(21) Appl. No.: 16/725,301

(22) Filed: Dec. 23, 2019

Related U.S. Application Data
(60) Provisional application No. 62/795,198, filed on Jan. 22, 2019.

(51) Int. Cl. B05D 1/28; B05D 7/14

(52) U.S. Cl. CPC B05D 1/28; B05D 2202/00; B05D 2401/20; B05D 7/14

(57) ABSTRACT

The present disclosure relates generally to a rolled metal article. In particular, the present disclosure provides an article comprising a metal substrate and a taggant sheared into the substrate. The metal substrate has an upper surface, a lower surface, and a middle portion therebetween. The taggant is embedded within at least one of an upper portion and a lower portion. The present disclosure provides a method for making a rolled metal article having a taggant embedded therein and a method for making an embossed metal coin including a taggant embedded therein.

### CROSS-REFERENCE TO RELATED APPLICATION

This application claims priority to Provisional Application No. 62/795,198, filed Jan. 22, 2019, which is herein incorporated by reference in its entirety.

### FIELD OF THE DISCLOSURE

The present disclosure relates generally to a rolled metal article containing a taggant. In particular, the present disclosure provides an article comprising a metal substrate and a taggant sheared into the substrate. In some embodiments, the metal substrate containing the taggant is useful as a marker for fraud prevention in metals such as bullion coinage.

### BACKGROUND

There is a demand for fraud-proof bullion coinage, markable in a time-efficient and cost-efficient manner, that are simple to authenticate. It is generally known to provide taggants on a surface of metal articles to enable authentication of the metal articles.

Electro plating has been disclosed to apply an authentication element by deposition of a metal layer with embedded particles on a metal substrate, however, electroplating is costly and time consuming. Cold-working, in which a metal is strengthened by changing its shape without the use of heat, has been disclosed for metal articles including a cold-worked metal-containing surface defining pores and having luminescent phosphor particles disposed within the pores. The cold-working was performed by striking an intermediate article with a die. A simpler, time-efficient, and cost-efficient method of forming metal articles with embedded particles is desired.

### SUMMARY

These and other needs are addressed by the various aspects and configurations of the present disclosure.

Various aspects of the present disclosure include a method of making a taggant embedded metal article. The method comprises dispersing a plurality of taggant particles in a liquid to form a dispersion; agitating the dispersion to form a uniformly distributed suspension; spraying the suspension onto a metal substrate to form a composite; and rolling the composite to shear the plurality of taggant particles into at least one of an upper portion and a lower portion of the metal substrate.

The method of making a taggant embedded metal article described herein above, wherein the metal substrate has an initial thickness of from at least 0.0001 mm to at most 500 mm.

The method(s) of making a taggant embedded metal article described herein above, wherein the step of rolling is optionally repeated at least once to form a taggant embedded substrate having a final thickness of from at least 0.5 mm to at most 100 mm.

The method(s) of making a taggant embedded metal article described herein above, wherein the taggant particles are embedded to a depth of at most about 20 μm.

The method(s) of making a taggant embedded metal article described herein above, wherein the liquid is a compound comprising a polar compound, a non-polar compound, or combinations thereof.

The method(s) of making a taggant embedded metal article described herein above, wherein the compound is at least one chosen from isopropyl alcohol (C₃H₈O), acetone, methanol, water, distilled water, vanishing oil, kerosene, grease, wax, and combinations thereof.

The method(s) of making a taggant embedded metal article described herein above, wherein the taggant particles comprise luminescent phosphor particles.

The method(s) of making a taggant embedded metal article described herein above, wherein the plurality of luminescent phosphor particles comprises a host crystal oxide-containing lattice material and at least one active ion comprising an absorbing ion and an emitting ion different than the absorbing ion.

The method(s) of making a taggant embedded metal article described herein above, wherein the taggant particles have an average particle size of from at least 0.1 μm to at most 10 μm.

The method(s) of making a taggant embedded metal article described herein above, wherein the dispersion has a concentration of from at least 0.026 g/L to at most 0.1.26 g/L.

Various aspects of the present disclosure include a method of making an embossed metal article having a taggant embedded therein. The method comprises providing a taggant embedded metal article as described herein above; and, embossing the taggant embedded metal article.

These and other advantages will be apparent from the disclosure of the aspects and configurations contained herein.

It should be understood that every maximum numerical limitation given throughout the present disclosure is deemed to include each and every lower numerical limitation as an alternative, as if such lower numerical limitations were expressly written herein. Every minimum numerical limitation given throughout the present disclosure is deemed to include each and every higher numerical limitation as an alternative, as if such higher numerical limitations were expressly written herein. Every numerical range given throughout the present disclosure is deemed to include each and every narrower numerical range that falls within such broader numerical range, as if such narrower numerical ranges were all expressly written herein.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects and configurations of the disclosure, as illustrated by the drawings referenced below.

FIG. 1 is a schematic cross-section side view of a metal substrate including a surface layer having sheared particles embedded therein according to an embodiment of the present disclosure.

FIG. 2 is a flow chart illustrating a method of making a rolled metal article according to embodiments of the present disclosure.

FIG. 3 is a flow chart illustrating a method of making an embossed metal coin having a taggant embedded therein according to embodiments of the present disclosure.

FIG. 4 is an optical micrograph of a cross-section side view of an article having taggant embedded in the upper portion according to embodiments of the present disclosure.

FIG. 5 is a scanning electron micrograph of a cross-section side view of an article having taggant embedded in the upper portion according to embodiments of the present disclosure.

FIGS. 6A-6F are top view surface elemental analyses of an article having taggant embedded therein according to embodiments of the present disclosure.

### DETAILED DESCRIPTION

Persons skilled in the art will readily appreciate that various aspects of the present disclosure can be realized by any number of methods and apparatus configured to perform the intended functions. It should also be noted that the accompanying drawing figures referred to herein are not necessarily drawn to scale but may be exaggerated to illustrate various aspects of the present disclosure, and in that regard, the drawing figures should not be construed as limiting.

The present disclosure relates generally to rolled metal articles having a taggant material embedded therein. The present disclosure addresses the need for providing processing of taggant embedded articles that are simple to authenticate thus providing a deterrent against fraud and obviates the need for complicated and expensive processing techniques. Thus, a taggant marked metal article may be achieved in a time-efficient and cost-efficient manner.

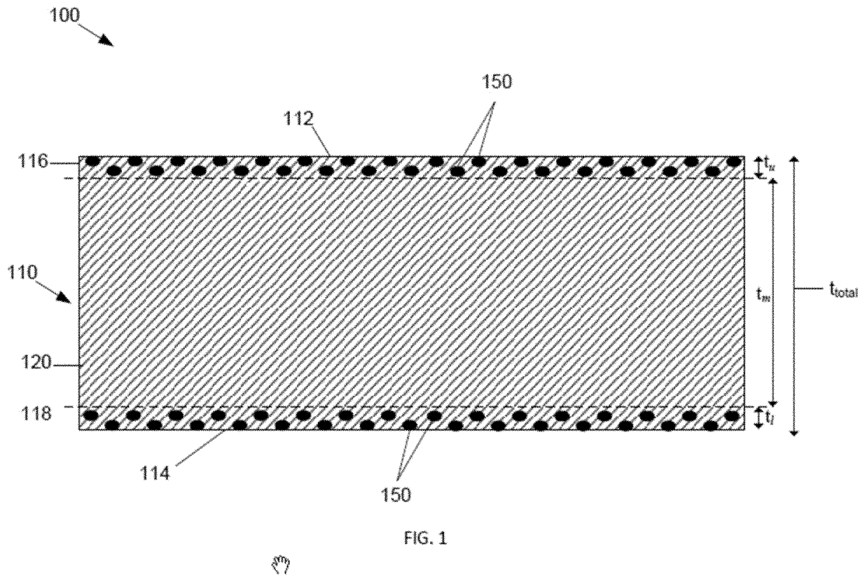

Various aspects of the present disclosure include a metal article 100. FIG. 1 depicts metal article 100 comprising a metal substrate 110 having an upper surface 112, a lower surface 114, and a total thickness, tₜₒₜₐₗ, therebetween. Metal article 100 further includes an upper portion 116 having thickness tᵤ, a lower portion 118 having thickness tₗ, and a middle portion 120 having thickness tₘ therebetween. The upper portion 116 is adjacent to and includes upper surface 112; lower portion 118 is adjacent to and includes lower surface 114. At least one of the upper portion 116 and the lower portion 118 includes a taggant material. For example, at least one of the upper portion 116 and the lower portion 118 includes a taggant material that is sheared or embedded into the metal substrate 110 with a shear force. In embodiments, the taggant material may be referred to as sheared taggant material, having been sheared during the process of embedding the taggant into the metal article.

Taggant particles 150 are distributed within the at least one of the upper portion 116 and the lower portion 118. In some embodiments, the taggant particles are distributed across the width and length of the metal substrate 110 such that the taggant particles are present across the surface area of the upper surface 112 and/or the lower surface 114. In embodiments, taggant particles 150 are embedded at varying depths throughout the upper portion 116 and the lower portion 118. In some embodiments, taggant particles 150 are embedded in the upper portion 116 and the lower portion 118 and are not present in the middle portion 120. In embodiments, the taggant particles are discontinuously distributed across the width and length of the metal substrate 110. For example, a continuous distribution of taggant particles is not required for detection by authentication devices; particles may be distributed non-continuously across the width and length detectable.

The metal article 100 can be formed from a starting metal substrate 110, and the metal substrate may be made from any material or combination of materials suitable for forming into a rolled metal article. In embodiments, the metal substrate is a metal chosen from silver (Ag), gold (Au), platinum (Pt), a silver (Ag) alloy, a gold (Au) alloy, a platinum (Pt) alloy, copper (Cu), a copper (Cu) alloy, and combinations thereof.

In embodiments, the metal article 100 has a total thickness, tₜₒₜₐₗ. Suitable total thickness tₜₒₜₐₗ is described herein. Taggant particles are disposed in the upper portion 116, having thickness tu, and/or in the lower portion 118, having thickness ti. Taggant 150 is embedded to a depth not to exceed tᵤ and/or ti from surfaces 112 and 114, respectively. In some embodiments, the taggant 150 is embedded to a depth of at most about 10%, about 5%, or about 2% of the total thickness tₜₒₜₐₗ. Middle portion 120, having thickness tₘ, is substantially devoid or devoid of taggant particles. In embodiments, the taggant particles are limited to the at least one of the upper portion and lower portion at a depth of about 20 μm from respective surfaces 112 and 114 as shown in FIG. 1.

In embodiments, the taggant particles have an average particle size of from at least 0.1 μm to at most 10 μm. Average particle size D50 is defined as the diameter at which 50% of a sample's mass is comprised of smaller particles. In embodiments, the average taggant particle size diameter (D50) may be about 0.5 μm, about 0.6 μm, about 0.7 μm, about 0.8 μm, about 0.9 μm, about 1.0 μm, about 1.1 μm, about 1.2 μm, about 1.3 μm, about 1.4 μm, about 1.5 μm, or about 1.6 μm, in some embodiments, the taggant particle size diameter (D50) is from about 0.5 μm to about 1.6 μm, from about 0.7 μm to about 1.3 μm, or from about 0.9 μm to about 1.1 μm. In a non-limiting example, the taggant particle size diameter is about 1.0 μm.

The amount of taggant loading into the at least one of an upper surface and a lower surface may be measured by calculation based upon concentration of dispersion applied, by elemental surface analysis of the at least one of the upper surface and the lower surface, and/or by other methods known in the art. The taggant material sheared into the substrate may penetrate at least one of the upper surface and the lower surface. Generally, the taggant loading is determined on a surface area (e.g. a top view) to which the taggant was applied and rolled and at least partially exposed and is at least sufficient for detection for authentication. In some embodiments, the taggant loading may be about 1.0×10⁻⁷ g/cm², about 5.0×10⁻⁷ g/cm², about 5.5×10⁻⁷ g/cm², about 1.0×10⁻⁶ g/cm², about 1.1×10⁻⁶ g/cm², about 2.2×10⁻⁶ g/cm², about 5.0×10⁻⁶ g/cm², about 1.0×10⁻⁵ g/cm², about 3.3×10⁻⁵ g/cm², about 5.0×10⁻⁵ g/cm², about 6.6×10⁻⁵ g/cm², about 1.0×10⁻⁴ g/cm², about 1.3×10⁻⁴ g/cm², or about 5.0×10⁻⁴ g/cm², in some embodiments, the taggant loading is from about 5.5×10⁻⁷ g/cm² to about 1.3×10⁻⁴ g/cm², from about 1.1×10⁻⁶ g/cm² to about 6.6×10⁻⁵ g/cm², or from about 2.2×10⁻⁶ g/cm² to about 3.3×10⁻⁵ g/cm².

The depth of taggant sheared into the substrate and embedded into the at least one of an upper portion and a lower portion may be measured by microstructural analysis of samples in cross-section. In some embodiments, the taggant depth is about 1 μm, about 5 μm, about 10 μm, about 15 μm, about 20 μm, about 30 μm, about 50 μm, or about 100 μm, in some embodiments, the taggant depth is from about 1 μm to about 100 μm, from about 1 μm to about 50 μm, or from about 1 μm to about 30 μm. The depth of taggant material embedded into the at least one of an upper portion and a lower portion may be measured by microstructural analysis of samples in cross-section as a percentage of total thickness. In some embodiments, the taggant depth is about 0.5%, about 1.0%, about 1.5%, about 2.0%, about 3.0%, about 4.0%, about 5.0%, or about 10.0% of the total thickness, in some embodiments, the taggant depth is from about 0.5% to about 10%, from about 1′)/0 to about 5.0% μm, or from about 1.0% to about 3.0% of the total thickness.

In embodiments, the taggant is discontinuously distributed into the at least one of the upper portion and the lower portion. The taggant may be made from any material or combination of materials suitable for use as a taggant. For example, the taggant may be particles that are harder than the metal substrate and having unique properties that are not easily reproduced so that authentication may be assured. In embodiments, the taggant comprises a plurality of luminescent phosphor particles. In embodiments, taggant particles are luminescent phosphor particles that provide a sufficiently strong absorption and emission to enable detection upon exposure to light from an exciting light source as is known in the art. The luminescent phosphor particles function by absorbing light or radiation from an exciting light source and then emitting radiation at particular wavelengths based upon chemistry of the luminescent phosphor particles. In embodiments, suitable luminescent phosphor particles exhibit high absorption of light or radiation from the exciting light source, high quantum efficiency, and ultimately emission at a high peak signal level. For example, in embodiments, suitable luminescent phosphor particles 150 emit in the infra-red spectrum (i.e., at wavelengths of greater than about 700 nm) and exhibit broad absorption bands in either the visible and/or infrared spectra. As another example, in other embodiments, suitable luminescent phosphor particles 150 have an emission at a wavelength of less than or equal to about 1100 nm, such as from about 700 nm to about 1100 nm, and an emission at a wavelength of greater than about 1100 nm.

In embodiments, the plurality of luminescent phosphor particles comprises a host crystal oxide-containing lattice material and at least one active ion comprising an absorbing ion and an emitting ion different than the absorbing ion. Suitable luminescent phosphor particles for use as taggant 150 include a host crystal lattice material and at least one active ion that includes an absorbing ion and an emitting ion that is different from the absorbing ion. The host crystal lattice material includes a material into which the active ions are incorporated (e.g., substituted). As used herein, the term “substituted” means substituted at any percentage, including low, medium, and high substitution percentages. The host crystal lattice material may be in the form of a crystal lattice into which different chemical constituents may substitute various positions within the crystal lattice. As used herein, the term “active ion” refers to an ion in the luminescent phosphor particles that may absorb, transfer, and/or emit energy. The amount of each ion substituted into the host crystal lattice material is generally described in terms of atomic percent, where the total number of ions of the host crystal lattice material that may be theoretically replaced by active ions is equal to 100%, which value does not include ions of the host crystal lattice material that cannot be replaced. An ion of the host crystal lattice material that allows for replacement with active ions may have similar size, the same valance state or similar loading, and similar coordination preference as the ions with which it will be replaced. As various substitutable positions within a host crystal lattice material may occur, the ions on each of these positions will be accounted for 100 atomic percent.

Examples of suitable host crystal lattice materials include oxide-containing material such as those chosen from an aluminate, a borate, a gallate, a niobate, vanadate, a garnet, a pervoskite, an oxysulfide, and combinations thereof. Specific examples of suitable garnet host crystal lattice materials include, but are not limited to, those chosen from yttrium aluminum garnet (YAG), yttrium gallium garnet (YGG), yttrium iron garnet (YIG), or gadolinium gallium garnet (GGG), gadolinium scandium gallium garnet (GSGG), and mixtures thereof, which are all both chemically stable and possess the desired hardness (e.g. Mohs hardness of taggant higher than that of the metal substrate) to resist pulverizing during rolling or rubbing out.

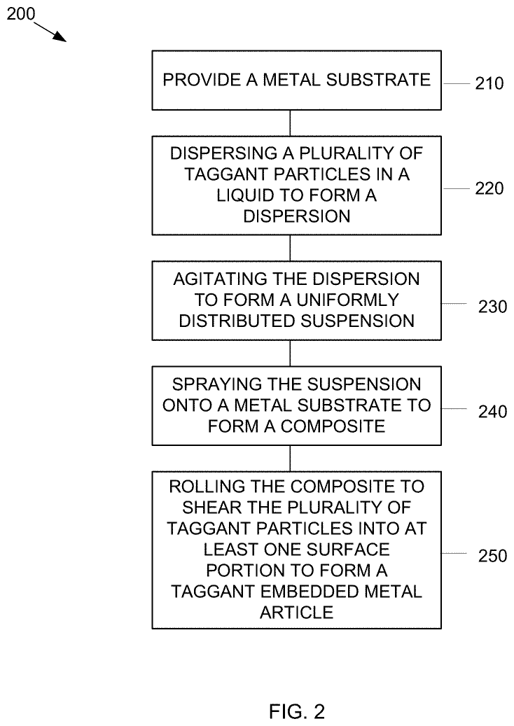

FIG. 2 is a flow chart illustrating a method 200 of making a rolled metal article according to embodiments of the present disclosure. According to embodiments, the rolled metal article may be, be similar to, include, or be included in the metal article 100 depicted in FIG. 1. Embodiments of the method 200 of making a rolled metal article include providing, as in block 210, a metal substrate 110, and the metal substrate may be made from any material or combination of materials suitable for forming into a marked article. In embodiments, the metal substrate is a metal chosen from silver (Ag), gold (Au), platinum (Pt), a silver (Ag) alloy, a gold (Au) alloy, a platinum (Pt) alloy, and combinations thereof. In embodiments, the initial metal substrate thickness may be about 0.0001, about 0.001 mm, about 0.01 mm, about 0.1 mm, 1 mm, about 2 mm, about 3 mm, about 4 mm, about 5 mm, about 6 mm, about 10 mm, about 50 mm, about 100 mm, or about 500 mm. In some embodiments, the initial metal substrate thickness is from about 0.0001 mm to about 500 mm, from about 0.01 mm to about 50 mm, from about 0.1 mm to about 10 mm, from about 1 mm to about 6 mm, from about 2 mm to about 5 mm, or from about 3 mm to about 4 mm. In a non-limiting example, the initial metal substrate thickness is about 3.734 mm (3734 μm=0.147 inches).

Embodiments of the method 200 of making a rolled metal article include dispersing, as in block 220, a plurality of taggant particles in a liquid to form a dispersion. The taggant may be any material suitable as described above. In embodiments, the taggant particles have an average particle size of from at least 0.1 μm to at most 10 μm. In embodiments, the average taggant particle size diameter (D50) may be about 0.5 μm, about 0.6 μm, about 0.7 μm, about 0.8 μm, about 0.9 μm, about 1.0 μm, about 1.1 μm, about 1.2 μm, about 1.3 μm, about 1.4 μm, about 1.5 μm, or about 1.6 μm, in some embodiments, the taggant particle size diameter (D50) is from about 0.5 μm to about 1.6 μm, from about 0.7 μm to about 1.3 μm, or from about 0.9 μm to about 1.1 μm. In a non-limiting example, the taggant particle size diameter is about 1.0 μm. In some embodiments, the taggant includes a plurality of luminescent phosphor particles comprising a host crystal oxide-containing lattice material and at least one active ion comprising an absorbing ion and an emitting ion different than the absorbing ion as described above. In embodiments, the taggant particles comprise luminescent phosphor particles. The dispersion may include taggant particles in any liquid suitable. In embodiments, the liquid comprises a polar compound, a non-polar compound, or combinations thereof. In embodiments, the liquid is at least one compound chosen from isopropyl alcohol (C₃H₈O), acetone, methanol, water, distilled water, vanishing oil, kerosene, grease, wax, and combinations thereof. In some embodiments, the dispersion has a concentration of about 0.026 g/L, about 0.052 g/L, about 0.078 g/L, about 0.105 g/L, about 0.131 g/L, about 0.157 g/L, about 0.315 g/L, about 0.630 g/L, or about 1.26 g/L, in some embodiments, the dispersion has a concentration from about 0.026 g/L to about 0.1.26 g/L, from about 0.052 g/L to about 0.630 g/L, or from about 0.105 g/L to about 0.315 g/L. In embodiments, the taggant comprises a plurality of luminescent phosphor particles, and the plurality of luminescent phosphor particles are dispersed in isopropyl alcohol (C₃H₈O). In embodiments, the taggant includes a plurality of luminescent phosphor particles comprising a host crystal oxide-containing lattice material and at least one active ion comprising an absorbing ion and an emitting ion different than the absorbing ion, and the plurality of luminescent phosphor particles comprising a host crystal oxide-containing lattice material and at least one active ion comprising an absorbing ion and an emitting ion different than the absorbing ion are dispersed in isopropyl alcohol (C₃H₈O).

As illustrated in block 230, the dispersion is agitated to form a uniformly distributed suspension. Examples of agitation include manually vigorously shaking the container in which the dispersion is maintained or may include mechanical agitation such as ultrasonic, sparging, rotating drum in bath, impeller in bath, and combinations thereof, or other methods as known in the art.

The suspension is sprayed onto the metal substrate to form a coated substrate as shown in block 240. Spraying methods and equipment may include manually pumped pressurized sprayers, high pressure sprayers with nozzles, fluidized feed system with pressurized hoppers, piezoelectric spray solvent delivery systems, liquid particle counting systems, and combinations thereof, or other methods as known in the art. The suspension is sprayed onto the surfaces of the metal substrate on which the taggant is desired. For example, the suspension is sprayed only onto the upper surface of the metal substrate if the taggant is desired only on the upper surface of the finished product, and the suspension is sprayed into the upper surface and the lower surface of the metal substrate if the taggant is desired on the both surfaces of the finished product.

The coated substrate is rolled, as in block 250, to shear the plurality of taggant particles into at least one portion (upper and/or lower portion) to form a taggant embedded metal substrate. The step of rolling may be performed hot or cold, in other words at temperatures according to the substrate material. Some materials require heat to relieve stresses and prevent cracking. The rolling in the examples herein was performed cold, for example at ambient or room temperature. Rolling provides advantages over other cold working techniques such as striking, for example, through the introduction of shear forces contributing to the embedding of the taggant into the substrate. The step of rolling is optionally repeated one or more additional times to form a taggant embedded article of a desired thickness. For example, the step of rolling can be repeated once, twice, thrice, or more so that the desired final thickness is achieved. In embodiments, the taggant embedded metal article can be subjected to three rolling passes. In embodiments, the final thickness of the taggant embedded metal article may be about 0.5 mm, about 1 mm, about 1.5 mm, about 2 mm, about 2.5 mm, about 3.0 mm, about 3.5 mm, about 5 mm, about 10 mm, or about 100 mm, in some embodiments, the final thickness of the taggant embedded metal article is from about 0.5 mm to about 100 mm, from about 1 mm to about 5 mm, or from about 1.5 mm to about 2.5 mm. The substrate may be any desired thickness and the method described herein may be adapted to any initial substrate thickness. Depending upon the substrate material, the thickness may be reduced to any desired thickness by repeating rolling passes to achieve desired thickness. In a non-limiting example, the final thickness of the taggant embedded metal article is about 2.032 mm (2032 μm=0.08″). Any rolling process equipment as known in the art is suitable for the method including automated rolling mills commercially available from various manufacturers. Articles rolled in accordance with the method described herein used Metal Rolling Mill Machines (Fenn-Torin, East Berlin, Conn.) to make multiple passes for reducing the thickness of the substrate while embedding taggant particles.

The taggant embedded metal article has a final total thickness (tₜₒₜₐₗ in FIG. 1) after rolling that is less than that of the metal substrate thickness prior to rolling, such as at the time of spraying the suspension onto the metal substrate and referred to herein as the initial metal substrate thickness. With each rolling pass, of which there may be multiple passes to achieve desired thickness, the substrate thickness is reduced, and the length is increase. The thickness before and after rolling with the taggant may be variable and tailored to specific needs. In embodiments, the initial metal substrate thickness may be about 1 mm, about 2 mm, about 3 mm, about 4 mm, about 5 mm, or about 6 mm, in some embodiments, the initial metal substrate thickness is from about 1 mm to about 6 mm, from about 2 mm to about 5 mm, or from about 3 mm to about 4 mm. In a non-limiting example, the initial metal substrate thickness is about 3.734 mm (3734 μm=0.147 inches). In embodiments, the final thickness of the taggant embedded metal article may be about 0.5 mm, about 1 mm, about 1.5 mm, about 2 mm, about 2.5 mm, about 3 mm, or about 3.5 mm, in some embodiments, the final thickness of the taggant embedded metal article is from about 0.5 mm to about 3.5 mm, from about 1 mm to about 3 mm, or from about 1.5 mm to about 2.5 mm. In a non-limiting example, the final thickness of the taggant embedded metal article is about 2.032 mm (2032 μm=0.08 inches).

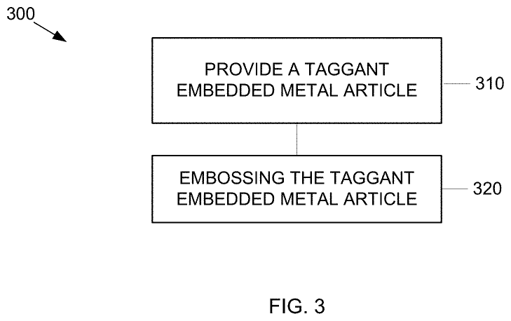

FIG. 3 is a flow chart illustrating a method 300 of making an embossed metal coin having a taggant embedded therein according to embodiments of the present disclosure. According to embodiments, the embossed metal coin may be the metal article 100 depicted in FIG. 1. In addition to making embossed metal coins, the method according to the present disclosure may also include making embossed bullion bar, slugs, or any other high value form factor of precious metals. Embodiments of the method 300 of making an embossed metal coin having a taggant embedded therein include, as in block 310, providing a taggant embedded substrate, such as the taggant embedded metal article of method 200 of FIG. 2. The process of embossing coins, as is known in the art, includes wherein a metal coin in the form of a disk-shaped blank or base element is typically placed between an upper and a lower die, which respectively bear the negative of the motif to be embossed. The blank or base element may be the taggant embedded metal article of method 200. Embodiments of the method 300 of making an embossed metal coin having a taggant embedded therein include, as in block 320, embossing the taggant embedded metal article. In an example, the blank or base element is then pressed between an upper and a lower die to complete embossment of the metal coin.

### EXAMPLES

A taggant composition, referred to herein as ‘E4189’, was used for each example described below. Silver (Ag) strips having initial thickness 3734 μm (0.147 inches) were used as metal substrates for the samples/examples described below.

Sample 1: Dry application of taggant composition. Dry E4189, in powder form, was applied to an Ag strip. In total about 0.2 g of E4189 was applied over a 6387.08 mm² (9.9 in²) Ag strip. This resulted in an excessive amount of very agglomerated and non-uniformly distributed taggant material on the Ag strip. No further analysis was performed.

Sample 2: Wet (pipette) application of taggant composition—high taggant loading. Wet E4189 was applied to an Ag strip. In total about 0.4 grams of E4189 was mixed into 100 g (127 mL) of isopropyl alcohol (IPA). Approximately 3 mL of the suspended E4189 was applied using a pipette over 5677.41 mm² (8.8 in²) Ag strip. The suspension was formed by shaking the E4189/IPA mixture vigorously in a screw-top container for about 1-2 minutes to deagglomerate the E4189 and to suspend the taggant in the IPA. To apply the suspension onto the Ag strip, a pipette was used to dispense the suspension onto the Ag strip. The dispensing was done very rapidly, within about 4 seconds after the vigorous shaking was complete. Sample 2 had a taggant loading equivalent to about 0.0094 g E4189. Sample 2 was evaluated by using a QC signal detector to assess the signal strength produced by the taggant. For Sample 2, the signal strength was over saturated indicating that the E4189 loading was too high.

Sample 3: Wet (spray) application of taggant composition—low taggant loading. Wet E4189 was applied to an Ag strip. Approximately 0.008 g E4189 was distributed in 127mL of IPA. This is about 50 times less than the concentration of Sample 2. A manually pumped pressurized sprayer was used to distribute the dispersion for Sample 3. A small screen cap on the bottom of the pickup tube (screen was >>1 μm) was removed from the manually pumped pressurized sprayer. The sprayer was then sealed and vigorously shaken, and the suspension was sprayed into the air for about 3 seconds to prime the tube. Then the suspension was immediately sprayed onto the Ag strip for

Sample 3. Sample 3 was evaluated by using a QC signal detector to assess the signal strength produced by the taggant. For Sample 3, the signal strength was weak or non-existent indicating that the E4189 loading was too low.

Additionally, it was determined visually that the spray distribution method used for Sample 3 provided a more uniform distribution of E4189 taggant onto the metal substrate Ag strip as compared to the pipette distribution method of Sample 2.

Sample 4: Wet (spray) application of taggant composition—lower taggant loading. Wet E4189 was applied to an Ag strip. Approximately 0.004 g E4189 was distributed in 254 mL of IPA. This is about 100 times less than the concentration of Sample 2. The same spray distribution method as for Sample 3 was used. Sample 4 was evaluated by using a QC signal detector to assess the signal strength produced by the taggant. For Sample 4, the signal strength was weak or non-existent indicating that the E4189 loading was too low.

Samples 5-7: Rolled metal with embedded taggant. Taggant suspensions for Samples 5, 6, and 7 were prepared and applied to the upper surface of an Ag strip by the spray distribution method as described for Samples 3 and 4. Sample 5 had a concentration of about 10 times less than the concentration of Sample 2; Sample 6 had a concentration of about 20 times less than the concentration of Sample 2; and Sample 7 had a concentration of about 30 times less than the concentration of Sample 2. The concentrations of the taggant suspensions of Samples 5, 6, and 7 are provided in Table 1.

TABLE 1

| Example | Weight E4189 Taggant/IPA | E4189 Concentration |
|---|---|---|
| 1 | 0.04 g/127 mL | 0.315 g/L |
| 2 | 0.02 g/127 mL | 0.158 g/L |
| 3 | 0.0133 g/127 mL | 0.105 g/L |

Samples 5-7 were then rolled in a Metal Rolling Mill Machines (Fenn-Torin, East Berlin, Conn.) using processing parameters suitable to the material and thickness of the Ag strip. Samples 5-7 were each rolled in three passes to reduce the thickness of the Ag strip from the initial thickness of 3734 μm (0.147 inches) to the final article thickness of 2032 μm (0.080 inches).

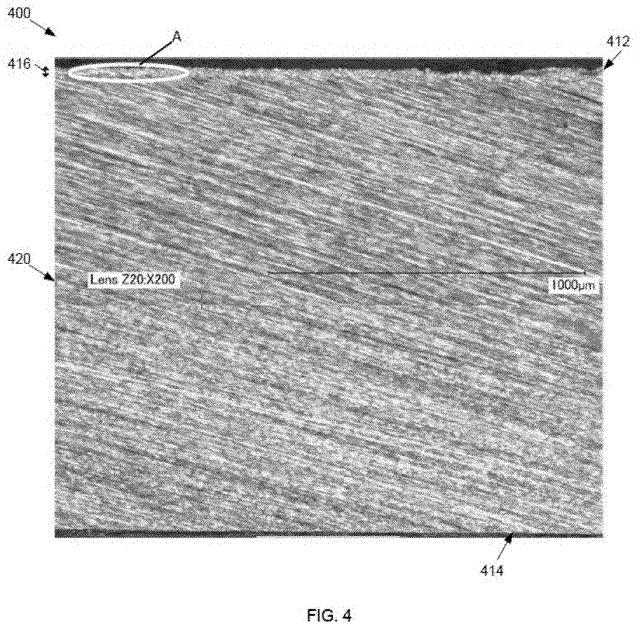

After rolling, a cross-sectional sample was prepared according Sample 2 in Table 1 above and is shown in FIG. 4 as analyzed at magnification 200× using a KEYENCE optical microscope (Keyence, Itasca, Ill.). The embedded taggant can be seen in the upper portion 416 of the metal article 400 as shown in area A. In FIG. 4, the taggant 150 is in a mottled morphology sheared and embedded into the metal substrate 420. The taggant suspension was only applied to the upper surface 412 of the substrate prior to rolling; it was not applied to the lower surface 414.

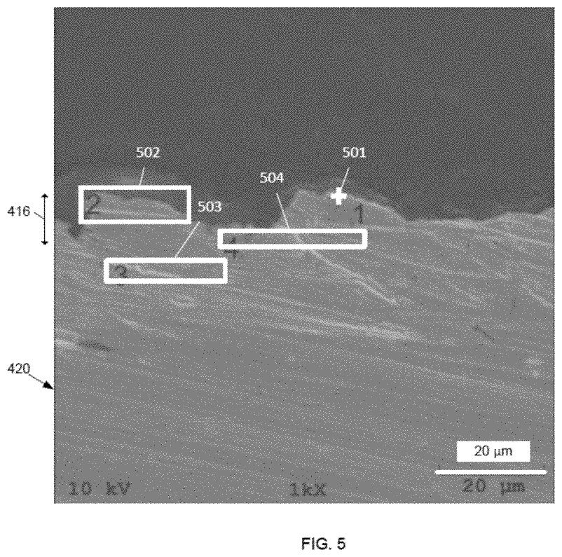

FIG. 5 is an enlarged view partial view of area A of FIG. 4. Using scanning electron microscopy (SEM) with elemental analysis by energy-dispersive X-ray (EDX), FIG. 5 shows the taggant associated elemental peaks in locations 501, 502, and 504. Location 503 did not indicate taggant associated elements present due its being deeper than the thickness of the upper portion 416. EDX analysis confirmed elemental peaks associated with the silver substrate 420.

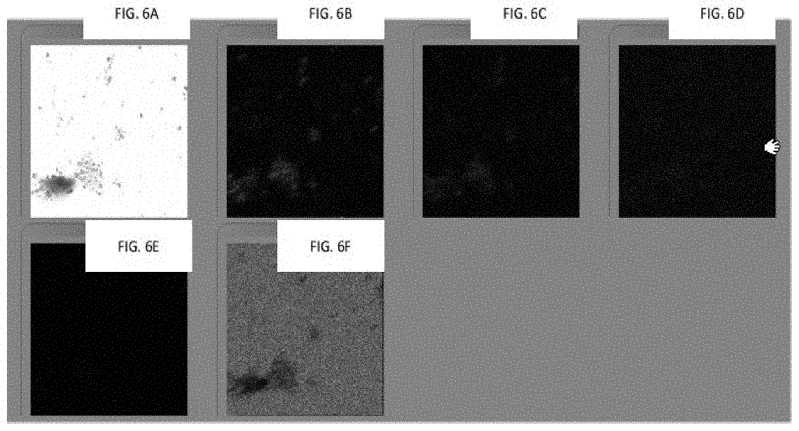

A top plan showing taggant distribution as viewed to the upper surface using SEM/EDX for elemental analysis is shown in FIG. 6A-6F. FIG. 6A shows a backscattered image wherein the taggant material appears dark in contrast with the substrate material. Elements associated with the taggant particles were detected corresponding to the taggant observable in FIG. 6A. Individual elemental analysis provided detection of a first element associated with the taggant in FIG. 6B, a second element associated with the taggant in FIG. 6C, a third element associated with the taggant in FIG. 6C, and a fourth element associated with the taggant in FIG. 6E. FIG. 6F shows the silver (Ag) element detection associated with the metal substrate.

Samples 5-7 were evaluated by using a QC signal detector to assess the signal strength produced by the taggant. For Samples 5-7, having E4189 concentrations from 0.105 g/L to 0.315 g/L embedded into an Ag strip by rolling in three passes, all provided detectable signal strength indicating that the E4189 loading was adequate for authentication.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

Moreover, though the description of the disclosure has included description of one or more aspects, embodiments, or configurations and certain variations and modifications, other variations, combinations, and modifications are within the scope of the disclosure, for example, as may be within the skill and knowledge of those in the art, after understanding the present disclosure. It is intended to obtain rights which include alternative aspects and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of making a taggant embedded metal article, the method comprising:
dispersing a plurality of taggant particles in a liquid to form a dispersion;
agitating the dispersion to form a uniformly distributed suspension;
spraying the suspension onto a metal substrate to form a composite; and
rolling the composite to shear the plurality of taggant particles into at least one of an upper portion and a lower portion of the metal substrate.

2. The method of claim 1, wherein the metal substrate has an initial thickness of from at least 0.0001 mm to at most 500 mm.

3. The method of claim 1, wherein the step of rolling is repeated at least once to form a taggant embedded substrate having a final thickness of from at least 0.5 mm to at most 100 mm.

4. The method of claim 1, wherein the taggant particles are embedded to a depth of at most about 20 μm.

5. The method of claim 1, wherein the liquid is a compound comprising a polar compound, a non-polar compound, or combinations thereof.

6. The method of claim 5, wherein the compound is at least one chosen from isopropyl alcohol (C₃H₈O), acetone, methanol, water, distilled water, vanishing oil, kerosene, grease, wax, and combinations thereof.

7. The method of claim 1, wherein the taggant particles comprise luminescent phosphor particles.

8. The method of claim 7, wherein the plurality of luminescent phosphor particles comprises a host crystal oxide-containing lattice material and at least one active ion comprising an absorbing ion and an emitting ion different than the absorbing ion.

9. The method of claim 1, wherein the taggant particles have an average particle size of from at least 0.1 μm to at most 10 μm.

10. The method of claim 1, wherein the dispersion has a concentration of from at least 0.026 g/L to at most 0.1.26 g/L.

11. A method of making an embossed metal article having a taggant embedded therein, the method comprising:
providing a taggant embedded metal article as in claim 1; and,
embossing the taggant embedded metal article.
